(19) United States
(12) Patent Application Publication
(10) Pub. No.: US 2026/0339157 A1
(43) Pub. Date: Oct. 29, 2026

(54) ANTI-COLLISION GLAZED UNIT

(71) Applicant: SAINT-GOBAIN GLASS FRANCE, COURBEVOIE (FR)

(72) Inventors: Théo CHEVALLIER, FARIBAULT, MN (US); Anne PENILLARD, AUBERVILLIERS (FR)

(21) Appl. No.: 18/995,604

(22) PCT Filed: Jul. 28, 2023
(86) PCT No.: PCT/EP2023/071077

§ 371 Date: Jan. 16, 2025

(30) Foreign Application Priority Data
Jul. 29, 2022 (FR) FR2207930

(51) Int. Cl. G02F 1/157; A01M 29/08; E06B 3/67; E06B 9/24; G02F 1/153

(52) U.S. Cl. CPC G02F 1/157; E06B 3/6722; E06B 9/24; G02F 1/1533; A01M 29/08; E06B 2009/2405; E06B 2009/2417; E06B 2009/2464

(57) ABSTRACT

A multi-glazed unit adapted to be mounted in a building, on a facade and/or on the roof, includes at least one exterior laminated glazed unit and an interior glazed unit separated by a gas gap and intended respectively to be arranged towards the exterior and interior of the building, the exterior laminated glazed unit including at least one electrochromic stack and a lamination interlayer, made of polymer material, interposed between an interior transparent substrate and an exterior transparent substrate including on its exterior face a textured pattern which contrasts with a background, wherein each subset of the texture pattern is separated from an adjacent subset by a distance less than 10.16 cm, and the pattern has relative to the background a visibility score SCORE greater than or equal to 0, and which satisfies the equation: SCORE=0.85*ΔS+0.15*ΔL.

The present invention relates to the field of multiple glazed units suitable for being mounted in a building, on a facade and/or on a roof. More specifically, the invention relates to so-called “anti-collision” glazed units which make it possible to avoid or at least limit the risks of a bird colliding with said glazed unit. The invention also relates to the manufacture of such a multiple glazed unit, as well as to its mounting in a building.

There is a need to make building glazed units clearly visible to birds so that they do not accidentally hit them. One known solution to meet this need is to apply to the glazed unit a pattern that is clearly visible to birds and which is sufficiently dense to signal to the birds that they cannot pass through it.

In this context, certain solutions known from the prior art have the disadvantage of not making this anti-collision pattern sufficiently visible to a bird, so that the risk of collision remains non-negligible.

There is therefore a need to provide an anti-collision multiple glazed unit provided with an anti-collision pattern that has satisfactory visibility for a bird.

The present invention addresses this need. More particularly, in at least one embodiment, the proposed technique relates to a multi-glazed unit adapted to be mounted in a building, on a facade and/or on the roof, comprising at least one exterior laminated glazed unit and an interior glazed unit separated by a gas gap and intended respectively to be arranged towards the exterior and interior of the building, said exterior laminated glazed unit comprising at least one electrochromic stack and a lamination interlayer, preferentially made of polymer material, even preferentially made of PVB, interposed between an interior transparent substrate and an exterior transparent substrate comprising on its exterior face a textured pattern which contrasts with a background (10), said pattern being characterized in that:
each subset of said pattern is separated from an adjacent subset by a distance less than 10.16 cm, preferentially less than 5.08 cm,
said pattern has relative to the background a visibility “SCORE” greater than or equal to 0, and which satisfies the equation: SCORE=0.85*ΔS+0.15*ΔL Where ΔS is the chromatic contrast and satisfies the equation [Math. 1]

$$Δ S = \sqrt{\begin{matrix}{( {w}_{1} {w}_{2} )}^{2} {( Δ {f}_{4} - Δ {f}_{3} )}^{2} + {( {w}_{1} {w}_{3} )}^{2} {( Δ {f}_{4} - Δ {f}_{2} )}^{2} + {( {w}_{1} {w}_{4} )}^{2} {( Δ {f}_{3} - Δ {f}_{2} )}^{2} + \\ {( {w}_{2} {w}_{3} )}^{2} {( Δ {f}_{4} - Δ {f}_{1} )}^{2} + {( {w}_{2} {w}_{4} )}^{2} {( Δ {f}_{3} - Δ {f}_{1} )}^{2} + {( {w}_{3} {w}_{4} )}^{2} {( Δ {f}_{2} - Δ {f}_{1} )}^{2} / \\ ( {( {w}_{1} {w}_{2} {w}_{3} )}^{2} + {( {w}_{1} {w}_{2} {w}_{4} )}^{2} + {( {w}_{1} {w}_{3} {w}_{4} )}^{2} + {( {w}_{2} {w}_{3} {w}_{4} )}^{2} )\end{matrix}}$$

Where “wi” is the Weber fraction representing the sensitivity of a cone “i” of the retina of a bird,
Where “Δfi” is the real perception difference between said pattern (9) and the background (10),
Where “fi” satisfies the equation:

fi=In(Qi/Qi_ref)

where Qi is the sensory response of a cone “i” of the retina of a bird and satisfies the equation [Math. 2]

Qᵢ=∫_{λ}Rᵢ(λ)S(λ)I(λ)dλ

Where “λ” is the wavelength, “S” is the considered spectrum, “i” is the illuminant D65 according to standard EN410 which describes the average solar spectrum and “Ri” is the sensitivity spectrum of said cone “i”,
Where “Qi_ref” corresponds to “Qi” with S equal to 1,
Where “ΔL” is the achromatic contrast and satisfies the equation:

ΔL=Δf_achromatic/w_achromatic

Where “w_achromatic” is equal to 0.1 is the Weber fraction representing the achromatic sensitivity of the retina of a bird,
Where “Δf_achromatic” is the difference in real achromatic perception between said pattern and the background,
Where “f_achromatic” satisfies the equation: f_achromatic=In(Q/Q_ref)
Where Q is the achromatic sensory response of the retina of a bird and satisfies the equation [Math. 3]

Q=∫_{λ}R(λ)S(λ)I(λ)dλ

Where “R” is the achromatic sensitivity spectrum,
Where “Q_ref” corresponds to “Q” with S equal to 1.

The concept of chromatic contrast ΔS is notably discussed in the publication Vorobyev, M., & Osorio, D., Receptor noise as a determinant of colour thresholds, Proc. R. Soc. Lond. B (1998) 265, 351-358 as the so-called ‘treshold distance’ under which wtimuli are indistinguishable, in particular for animal having a tetrachromatique vision, such as birds. However, contrary to the visibility score “SCORE”, the model developed in this publication ignored any achromatic signal.

Within the meaning of the invention, a multi-glazed unit means a plurality of glazed units—laminated or not—spaced apart and separated by one or two gas or vacuum gaps, depending on whether the multi-glazed unit is a double or triple glazed unit. According to the invention, an anti-collision pattern is textured on the exterior face of the exterior transparent substrate, that is, the face of the multi-glazed unit intended to be positioned outside the building. A so-called “textured” surface is a surface for which the surface irregularities vary at a scale greater than the wavelength of the radiation incident on the surface. Incident radiation, with a given angle, is then transmitted and reflected in a diffuse manner by the surface, that is, in a plurality of directions.

The textured pattern formed on the exterior face of the multi-glazed unit contrasts with the background in the sense that it is visually distinct therefrom, at least from the viewpoint of a bird. This background therefore corresponds to a surface defined in opposition to the textured pattern, such as a negative thereof.

The present invention resides firstly in selecting an anti-collision pattern based on a geometric criterion but also on a contrast criterion: the visibility score. This “SCORE” has excellent reliability, since it takes into account the optical perception of a bird in all its complexity, and in particular with regard to the both chromatic and achromatic sensitivity of its retina. A multi-glazed unit having a score greater than or equal to 0 thus makes it possible to satisfactorily limit the risk of a bird colliding with a glazed unit.

The present invention secondly resides in the combination, within the multi-glazed unit, of such an anti-collision unit with an electrochromic stack.

An electrochromic stack, also called an electrochemical functional system with electrically controllable optical and/or energy properties, comprises at least one electrochemically active layer arranged between a first electrode layer and a second electrode coating, the at least one electrochemically active layer being adapted to switch, under the effect of an appropriate electrical supply and reversibly, between a clear state and a tinted state, the optical and/or energy properties of which vary. Such properties particularly relate to transmission, absorption, reflection, or light scattering. The induced variation generally occurs in the optical field (infrared, visible, ultraviolet) and/or in other fields of electromagnetic radiation, hence why it is called a device with variable optical and/or energy properties, as the optical domain is not necessarily the only domain concerned.

As detailed in the description, the combination, within the multi-glazed unit, of an anti-collision pattern and of an electrochromic stack has the advantage of increasing the contrast between the pattern and the background, as perceived by a bird. In other words, the anti-collision pattern appears more visible to a bird.

According to a particular embodiment, said interior transparent substrate is coated with said electrochromic stack, said electrochromic stack preferentially being in contact with said gas gap.

According to a particular embodiment, said multi-glazed unit comprises at least one reflective layer arranged between the interior transparent substrate and the external face of the exterior transparent substrate.

As detailed in the description, the addition of such a reflective layer makes it possible to increase the reflection at the textured pattern, and therefore improves its visibility from a bird's viewpoint.

According to a particular embodiment, said at least one reflective layer is arranged on the internal face of the exterior transparent substrate.

According to a particular embodiment, said at least one reflective layer is composed of silicon nitride and/or of oxide MOx (M=Si, Sn, Zn) and/or of metal M (M=Ni, Cr, Ti, Ag)

The Weber fraction “wi” representing the sensitivity of a cone “i” of the retina of a bird is selected according to the following specific values: w₁=0.2; w₂=0.14142; w₃=0.14142; w₄=0.1.

Such a set of Weber fractions corresponds to the typical sensitivity of a bird. The selection of such a set of Weber fractions therefore makes it possible to provide an anti-collision pattern the visibility of which is excellent for the large majority of avian species.

According to a particular embodiment, said pattern comprises wavy or rectilinear strips.

According to a particular embodiment, said pattern comprises dots.

The invention also relates to a method comprising a step of manufacturing such a multi-glazed unit.

According to particular embodiments, the texturing of the exterior face to obtain the anti-collision pattern may be achieved by any known method of texturing, for example by embossing the surface of the substrate heated beforehand to a temperature at which it can be deformed, in particular by rolling using a roller whose surface has texturing complementary to the texturing to be formed on the substrate; by abrasion by means of particles or abrasive surfaces, in particular by sand blasting; by chemical treatment, especially treatment with acid in the case of a glass substrate; by molding, especially injection molding in the case of a substrate of thermoplastic polymer; by etching.

The invention also relates to a method comprising a step of mounting in a building, on a facade and/or on the roof, of at least one such multi-glazed unit.

Other features and advantages of the invention will become apparent upon reading the following description of particular embodiments, provided by way of simple illustrative and non-limiting examples, and from the attached figures, whereby:

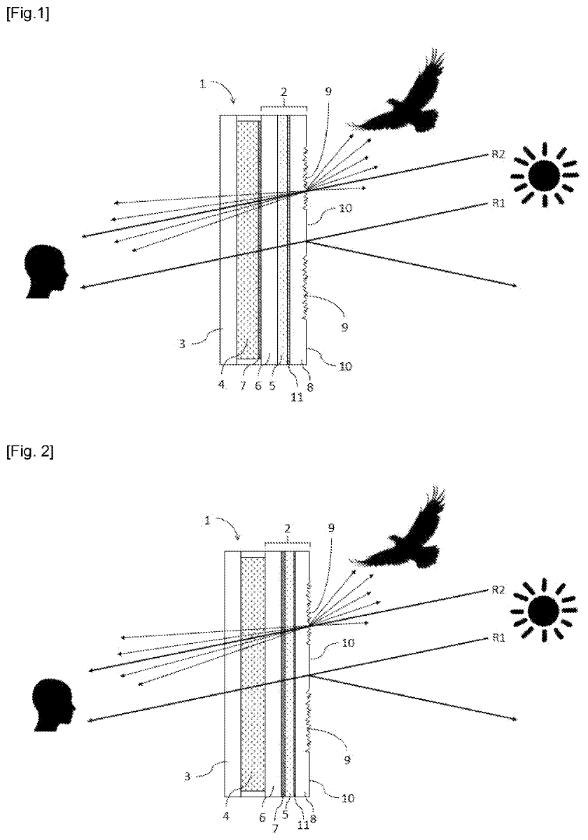

FIG. 1 is a schematic cross-sectional view of a multiple glazed unit according to one embodiment of the invention,

FIG. 2 is a schematic cross-sectional view of a multiple glazed unit according to an alternative embodiment of the invention,

The different features illustrated by the figures are not depicted at full scale, as the focus is on the depiction of the general operation of the invention. In particular, the size of the texturing of the exterior face of the multiple glazed unit is significantly magnified. In reality, the detail of such texturing cannot be distinguished by the naked eye. By the same logic, the exact path of the incident solar rays within the multiple glazed unit is not detailed—in particular the angular deviations that can be generated at each interface—as the diagram focused more on the illustration of the diffuse reflection generated at the pattern, as opposed to the specular reflection generated at the background.

According to a particular embodiment and as shown by FIG. 1, the invention relates to a multiple glazed unit 1 adapted to be mounted in a building, on a facade and/or on the roof, comprising at least one exterior laminated glazed unit 2 and an interior glazed unit 3 separated from a gas gap 4 and intended respectively to be arranged towards the exterior and the interior of the building. In FIG. 1, a sun and a bird are positioned outside the building, while an observer is positioned inside. The exterior laminated glazed unit 2 comprises at least one lamination interlayer 5 made of PVB (polyvinyl butyral), interposed between an interior transparent substrate 6 coated with an electrochromic stack 7 in contact with said gas gap 4, and an exterior transparent substrate 8 comprising on its exterior face a textured pattern 9—of which two subsets are shown in FIG. 1—which contrasts with a background 10. A reflective layer 11 is arranged on the inner face of the transparent exterior substrate 8.

Each of said transparent substrates may be constituted of transparent polymer, transparent glass, or transparent ceramic.

According to an alternative embodiment shown in FIG. 2, the multi-glazed unit 1 differs from that described above and shown in FIG. 1 in that the electrochromic stack 7 is deposited on the interior transparent substrate 6, on the side of the lamination interlayer 5.

According to an alternative embodiment not shown, the electrochromic stack 7 is deposited on the interior face of the transparent exterior substrate 8, on the side of the lamination interlayer 5.

In order to highlight the scattering effect generated at the textured pattern 9, two incident solar light rays R1 and R2 are shown in FIGS. 1 and 2. The first radius R1 passes through the transparent exterior substrate 8 at the background 10. Since the interface is smooth at this location, as opposed to the textured interface of the pattern 9, the radius R1 is transmitted and reflected in specular fashion by the surface. The part of the ray R1 reflected by the glazed unit is thus invisible to the bird, which therefore does not see this background area 10 of the exterior face 8. By contrast, the second ray R2 passes through the transparent exterior substrate 8 at a subset of the textured pattern 9. The second radius R2 is then transmitted and reflected in a diffuse manner, that is, in a plurality of directions. Part of the rays reflected in a diffuse manner can then be perceived by the bird, which then distinguishes a pattern 9, by contrast with the background 10.

In order to better understand what is perceived by the bird, it is necessary to detail the composition of the light spectrum perceived on the one hand at the pattern 9, and on the other hand at the background 10. In general, the spectrum observed by the bird can be considered to be the sum of the diffuse light exiting the building and the reflected solar light scattered by the multi-glazed unit.

At the background 10, which is a smooth interface, the reflection is specular and can therefore be ignored. As for the diffuse light exiting the building, it can be estimated that it corresponds to the sunlight transmitted into the building, reflected in a diffuse manner on the interior walls and retransmitted outward.

The “BKG” spectrum of the background 10 as seen by the bird is therefore as follows:

BKG=%T_window\hat{ }2*%R_wall
Where % T_window is the overall transmission of the glazed unit,
Where % R_wall can be considered to be a fixed value of 40%, in the event that the interior walls of the building return 40% of the solar radiation (albedo).

At the pattern 9, which is a textured interface, the reflection is diffuse and must therefore be added. As for the diffuse light exiting the building, it is transmitted in a diffuse manner by the pattern 9.

The “PTRN” spectrum of the pattern 9 as seen by the bird is therefore as follows:

PTRN=% T_window\hat{ }2*% R_wall+% R_pattern
Where % R_pattern is its diffuse reflection at said pattern 9.

According to the invention, the textured pattern 9 is characterized in that:
each subset of said pattern 9 is separated from an adjacent subset by a distance less than 5.08 cm, and
said pattern 9 has relative to the background 10 a visibility score “SCORE” greater than or equal to 0, and which satisfies the equation: SCORE=0.85*ΔS+0.15*ΔL

According to the invention, the Weber fraction “wi” representing the sensitivity of a cone “i” of the retina of a bird is selected according to the following specific values: W1=0.2; W2=0.14142; W3=0.14142; W4=0.1.

As indicated above, the value of this SCORE directly depends on the sensory response (Q; Qi) of the retina of the bird, of which one of the components “S” is the value of the spectrum observed.

This makes it possible to better understand the advantage provided by the implementation of an electrochromic stack 7, in combination with the anti-collision feature 9. This electrochromic stack, by being tinted, will generate a significant drop in the light transmission through the multi-glazed unit (% T_window). With reference to the definitions given above of the spectra of the pattern 9 (“PTRN”) and of the background 10 (“BKG”), it will be understood that when the light transmission drops, the first part of the calculation of the spectrum (% T_window\hat{ }2*% R_wall) tends toward 0. The “BKG” spectrum of the background 10 then tends to 0, whereas the “PTRN” spectrum of the pattern 9 tends toward the diffuse reflection value “% R_pattern” of the pattern 9, hence an increase in the contrast perceived by the bird between the pattern 9 and the background 10. When the electrochromic stack switches to its tinted state, the anti-collision pattern 9 is consequently more visible to the bird.

Still with reference to the definitions given above of the spectra of the pattern 9 (“PTRN”) and of the background 10 (“BKG”), it will be understood that adding a reflective layer 11 makes it possible to increase the diffuse reflection at the pattern 9 (“% R_pattern”). Although the specular reflection at the background 10 is also increased, this does not impact how it is perceived by the bird, due to its specular nature. The contrast perceived by the bird between the pattern 9 and the background 10 is therefore increased by adding the reflective layer 11, which therefore makes the anti-collision pattern 9 more visible.

The visual functions Ri and R used for the present invention are detailed in Table 1 [Tables 1] below, as a function of the wavelength A:

| | | | | | Achro- |
|---|---|---|---|---|---|
| | Visual | | | | matic |
| λ | R1 | R2 | R3 | R4 | Rachro |
| 300 | 0.00E+00 | 0 | 0 | 0 | 1.99E−06 |
| 301 | 0.00E+00 | 0 | 0 | 0 | 2.36E−06 |
| 302 | 0.00E+00 | 0 | 0 | 0 | 2.95E−06 |
| 303 | 0.00E+00 | 0 | 0 | 0 | 3.85E−06 |
| 304 | 0.00E+00 | 0 | 0 | 0 | 5.25E−06 |
| 305 | 0.00E+00 | 0 | 0 | 0 | 7.38E−06 |
| 306 | 0.00E+00 | 0 | 0 | 0 | 1.06E−05 |
| 307 | 0.00E+00 | 0 | 0 | 0 | 1.54E−05 |
| 308 | 0.00E+00 | 0 | 0 | 0 | 2.27E−05 |
| 309 | 0.00E+00 | 0 | 0 | 0 | 3.30E−05 |
| 310 | 0.00E+00 | 0 | 0 | 0 | 4.67E−05 |
| 311 | 0.00E+00 | 0 | 0 | 0 | 6.38E−05 |
| 312 | 0.00E+00 | 0 | 0 | 0 | 8.30E−05 |
| 313 | 0.00E+00 | 0 | 0 | 0 | 1.03E−04 |
| 314 | 0.00E+00 | 0 | 0 | 0 | 1.23E−04 |
| 315 | 0.00E+00 | 0 | 0 | 0 | 1.42E−04 |
| 316 | 2.33E−05 | 0 | 0 | 0 | 1.59E−04 |
| 317 | 1.49E−04 | 0 | 0 | 0 | 1.75E−04 |
| 318 | 2.72E−04 | 0 | 0 | 0 | 1.88E−04 |
| 319 | 3.92E−04 | 0 | 0 | 0 | 2.00E−04 |
| 320 | 5.11E−04 | 0 | 0 | 0 | 2.10E−04 |
| 321 | 6.27E−04 | 0 | 0 | 0 | 2.19E−04 |
| 322 | 7.41E−04 | 0 | 0 | 0 | 2.27E−04 |
| 323 | 8.53E−04 | 0 | 0 | 0 | 2.35E−04 |
| 324 | 9.62E−04 | 0 | 0 | 0 | 2.42E−04 |
| 325 | 1.07E−03 | 0 | 0 | 0 | 2.49E−04 |
| 326 | 1.17E−03 | 0 | 0 | 0 | 2.56E−04 |
| 327 | 1.28E−03 | 0 | 0 | 0 | 2.62E−04 |
| 328 | 1.38E−03 | 0 | 0 | 0 | 2.68E−04 |
| 329 | 1.48E−03 | 0 | 0 | 0 | 2.74E−04 |
| 330 | 1.57E−03 | 0 | 0 | 0 | 2.80E−04 |
| 331 | 1.67E−03 | 0 | 0 | 0 | 2.86E−04 |
| 332 | 1.76E−03 | 0 | 0 | 0 | 2.92E−04 |
| 333 | 1.85E−03 | 0 | 0 | 0 | 2.97E−04 |
| 334 | 1.95E−03 | 0 | 0 | 0 | 3.03E−04 |
| 335 | 2.04E−03 | 0 | 0 | 0 | 3.08E−04 |
| 336 | 2.12E−03 | 0 | 0 | 0 | 3.13E−04 |
| 337 | 2.21E−03 | 0 | 0 | 0 | 3.18E−04 |
| 338 | 2.30E−03 | 0 | 0 | 0 | 3.23E−04 |
| 339 | 2.39E−03 | 0 | 0 | 0 | 3.28E−04 |
| 340 | 2.48E−03 | 0 | 0 | 0 | 3.33E−04 |
| 341 | 2.56E−03 | 0 | 0 | 0 | 3.38E−04 |
| 342 | 2.65E−03 | 0 | 0 | 0 | 3.43E−04 |
| 343 | 2.74E−03 | 0 | 0 | 0 | 3.48E−04 |
| 344 | 2.83E−03 | 0 | 0 | 0 | 3.53E−04 |
| 345 | 2.92E−03 | 0 | 0 | 0 | 3.59E−04 |
| 346 | 3.01E−03 | 0 | 0 | 0 | 3.64E−04 |
| 347 | 3.11E−03 | 0 | 0 | 0 | 3.69E−04 |
| 348 | 3.20E−03 | 0 | 0 | 0 | 3.74E−04 |
| 349 | 3.30E−03 | 0 | 0 | 0 | 3.78E−04 |
| 350 | 3.40E−03 | 0 | 0 | 0 | 3.83E−04 |
| 351 | 3.50E−03 | 0 | 0 | 0 | 3.87E−04 |
| 352 | 3.61E−03 | 0 | 0 | 0 | 3.92E−04 |
| 353 | 3.71E−03 | 0 | 0 | 0 | 3.95E−04 |
| 354 | 3.82E−03 | 0 | 0 | 0 | 3.99E−04 |
| 355 | 3.93E−03 | 0 | 0 | 0 | 4.03E−04 |
| 356 | 4.05E−03 | 0 | 0 | 0 | 4.05E−04 |
| 357 | 4.17E−03 | 0 | 0 | 0 | 4.07E−04 |
| 358 | 4.29E−03 | 0 | 0 | 0 | 4.10E−04 |
| 359 | 4.41E−03 | 0 | 0 | 0 | 4.12E−04 |
| 360 | 4.54E−03 | 0 | 0 | 0 | 4.14E−04 |
| 361 | 4.67E−03 | 0 | 0 | 0 | 4.15E−04 |
| 362 | 4.80E−03 | 0 | 0 | 0 | 4.16E−04 |
| 363 | 4.94E−03 | 0 | 0 | 0 | 4.17E−04 |
| 364 | 5.07E−03 | 0 | 0 | 0 | 4.18E−04 |
| 365 | 5.22E−03 | 0 | 0 | 0 | 4.19E−04 |
| 366 | 5.36E−03 | 0 | 0 | 0 | 4.20E−04 |
| 367 | 5.51E−03 | 0 | 0 | 0 | 4.21E−04 |
| 368 | 5.65E−03 | 0 | 0 | 0 | 4.23E−04 |
| 369 | 5.80E−03 | 0 | 0 | 0 | 4.23E−04 |
| 370 | 5.96E−03 | 0 | 0 | 0 | 4.24E−04 |
| 371 | 6.11E−03 | 0 | 0 | 0 | 4.25E−04 |
| 372 | 6.27E−03 | 0 | 0 | 0 | 4.26E−04 |
| 373 | 6.43E−03 | 0 | 0 | 0 | 4.26E−04 |
| 374 | 6.58E−03 | 0 | 0 | 0 | 4.26E−04 |
| 375 | 6.74E−03 | 0 | 0 | 0 | 4.26E−04 |
| 376 | 6.91E−03 | 0 | 0 | 0 | 4.26E−04 |
| 377 | 7.07E−03 | 0 | 0 | 0 | 4.25E−04 |
| 378 | 7.23E−03 | 0 | 0 | 0 | 4.24E−04 |
| 379 | 7.39E−03 | 0 | 0 | 0 | 4.23E−04 |
| 380 | 7.55E−03 | 0 | 0 | 0 | 4.22E−04 |
| 381 | 7.71E−03 | 0 | 0 | 0 | 4.21E−04 |
| 382 | 7.87E−03 | 0 | 0 | 0 | 4.19E−04 |
| 383 | 8.03E−03 | 0 | 0 | 0 | 4.17E−04 |
| 384 | 8.19E−03 | 0 | 0 | 0 | 4.16E−04 |
| 385 | 8.35E−03 | 0 | 0 | 0 | 4.14E−04 |
| 386 | 8.50E−03 | 0 | 0 | 0 | 4.12E−04 |
| 387 | 8.66E−03 | 0 | 0 | 0 | 4.09E−04 |
| 388 | 8.81E−03 | 0 | 0 | 0 | 4.07E−04 |
| 389 | 8.95E−03 | 0 | 0 | 0 | 4.04E−04 |
| 390 | 9.10E−03 | 0 | 0 | 0 | 4.02E−04 |
| 391 | 9.24E−03 | 0 | 0 | 0 | 3.99E−04 |
| 392 | 9.38E−03 | 0 | 0 | 0 | 4.02E−04 |
| 393 | 9.52E−03 | 0 | 0 | 0 | 4.09E−04 |
| 394 | 9.65E−03 | 0 | 0 | 0 | 4.16E−04 |
| 395 | 9.78E−03 | 0 | 0 | 0 | 4.23E−04 |
| 396 | 9.91E−03 | 0 | 0 | 0 | 4.29E−04 |
| 397 | 1.00E−02 | 0 | 0 | 0 | 4.35E−04 |
| 398 | 1.01E−02 | 0 | 0 | 0 | 4.41E−04 |
| 399 | 1.03E−02 | 0 | 0 | 0 | 4.46E−04 |
| 400 | 1.04E−02 | 0 | 0 | 0 | 4.51E−04 |
| 401 | 1.05E−02 | 0 | 0 | 0 | 4.56E−04 |
| 402 | 1.06E−02 | 0 | 0 | 0 | 4.61E−04 |
| 403 | 1.07E−02 | 0 | 0 | 0 | 4.65E−04 |
| 404 | 1.07E−02 | 0 | 0 | 0 | 4.69E−04 |
| 405 | 1.08E−02 | 0 | 0 | 0 | 4.73E−04 |
| 406 | 1.09E−02 | 0 | 0 | 0 | 4.76E−04 |
| 407 | 1.10E−02 | 0 | 0 | 0 | 4.79E−04 |
| 408 | 1.10E−02 | 0 | 0 | 0 | 4.97E−04 |
| 409 | 1.11E−02 | 0 | 0 | 0 | 5.17E−04 |
| 410 | 1.11E−02 | 0 | 0 | 0 | 5.36E−04 |
| 411 | 1.12E−02 | 0 | 0 | 0 | 5.55E−04 |
| 412 | 1.12E−02 | 0 | 0 | 0 | 5.73E−04 |
| 413 | 1.12E−02 | 0 | 0 | 0 | 5.91E−04 |
| 414 | 1.13E−02 | 0 | 0 | 0 | 6.09E−04 |
| 415 | 1.13E−02 | 0 | 0 | 0 | 6.27E−04 |
| 416 | 1.13E−02 | 0 | 0 | 0 | 6.44E−04 |
| 417 | 1.13E−02 | 0 | 0 | 0 | 6.62E−04 |
| 418 | 1.12E−02 | 0 | 0 | 0 | 6.79E−04 |
| 419 | 1.12E−02 | 0 | 0 | 0 | 6.96E−04 |
| 420 | 1.12E−02 | 0 | 0 | 0 | 7.14E−04 |
| 421 | 1.11E−02 | 0 | 0 | 0 | 7.31E−04 |
| 422 | 1.11E−02 | 0 | 0 | 0 | 7.48E−04 |
| 423 | 1.10E−02 | 0 | 0 | 0 | 7.66E−04 |
| 424 | 1.10E−02 | 0 | 0 | 0 | 7.83E−04 |
| 425 | 1.09E−02 | 0 | 0 | 0 | 8.01E−04 |
| 426 | 1.08E−02 | 0 | 0 | 0 | 8.18E−04 |
| 427 | 1.07E−02 | 0 | 0 | 0 | 8.36E−04 |
| 428 | 1.06E−02 | 1E−08 | 0 | 0 | 8.54E−04 |
| 429 | 1.05E−02 | 2E−08 | 0 | 0 | 8.72E−04 |
| 430 | 1.04E−02 | 7E−08 | 0 | 0 | 8.91E−04 |
| 431 | 1.02E−02 | 0.0000002 | 0 | 0 | 9.10E−04 |
| 432 | 1.01E−02 | 5.5E−07 | 0 | 0 | 9.29E−04 |
| 433 | 9.94E−03 | 1.37E−06 | 0 | 0 | 9.49E−04 |
| 434 | 9.78E−03 | 3.17E−06 | 0 | 0 | 9.67E−04 |
| 435 | 9.61E−03 | 6.84E−06 | 0 | 0 | 9.86E−04 |
| 436 | 9.43E−03 | 1.386E−05 | 0 | 0 | 1.00E−03 |
| 437 | 9.25E−03 | 2.644E−05 | 0 | 0 | 1.02E−03 |
| 438 | 9.06E−03 | 0.0000478 | 0 | 0 | 1.04E−03 |
| 439 | 8.86E−03 | 8.223E−05 | 0 | 0 | 1.06E−03 |
| 440 | 8.65E−03 | 0.0001352 | 0 | 0 | 1.07E−03 |
| 441 | 8.44E−03 | 0.0002131 | 0 | 0 | 1.09E−03 |
| 442 | 8.22E−03 | 0.0003233 | 0 | 0 | 1.10E−03 |
| 443 | 7.99E−03 | 0.0004737 | 0 | 0 | 1.12E−03 |
| 444 | 7.76E−03 | 0.000672 | 0 | 0 | 1.14E−03 |
| 445 | 7.52E−03 | 0.0009257 | 0 | 0 | 1.15E−03 |
| 446 | 7.28E−03 | 0.0012411 | 0 | 0 | 1.17E−03 |
| 447 | 7.04E−03 | 0.0016232 | 0 | 0 | 1.19E−03 |
| 448 | 6.79E−03 | 0.0020751 | 0 | 0 | 1.21E−03 |
| 449 | 6.54E−03 | 0.0025979 | 0 | 0 | 1.22E−03 |
| 450 | 6.29E−03 | 0.0031907 | 0 | 0 | 1.24E−03 |
| 451 | 6.04E−03 | 0.0038503 | 0 | 0 | 1.26E−03 |
| 452 | 5.78E−03 | 0.0045716 | 0 | 0 | 1.29E−03 |
| 453 | 5.53E−03 | 0.0053479 | 0 | 0 | 1.31E−03 |
| 454 | 5.28E−03 | 0.006171 | 0 | 0 | 1.33E−03 |
| 455 | 5.03E−03 | 0.0070318 | 0 | 0 | 1.36E−03 |
| 456 | 4.78E−03 | 0.0079203 | 0 | 0 | 1.38E−03 |
| 457 | 4.54E−03 | 0.0088266 | 0 | 0 | 1.41E−03 |
| 458 | 4.30E−03 | 0.0097403 | 0 | 0 | 1.44E−03 |
| 459 | 4.06E−03 | 0.0106519 | 0 | 0 | 1.47E−03 |
| 460 | 3.83E−03 | 0.0115518 | 0 | 0 | 1.50E−03 |
| 461 | 3.60E−03 | 0.0124314 | 0 | 0 | 1.54E−03 |
| 462 | 3.38E−03 | 0.0132831 | 0 | 0 | 1.57E−03 |
| 463 | 3.17E−03 | 0.0140998 | 0 | 0 | 1.61E−03 |
| 464 | 2.97E−03 | 0.0148757 | 0 | 0 | 1.64E−03 |
| 465 | 2.77E−03 | 0.0156057 | 0 | 0 | 1.68E−03 |
| 466 | 2.58E−03 | 0.0162858 | 0 | 0 | 1.72E−03 |
| 467 | 2.39E−03 | 0.0169127 | 0 | 0 | 1.76E−03 |
| 468 | 2.22E−03 | 0.0174841 | 0 | 0 | 1.80E−03 |
| 469 | 2.06E−03 | 0.0179985 | 0 | 0 | 1.85E−03 |
| 470 | 1.90E−03 | 0.0184549 | 0 | 0 | 1.89E−03 |
| 471 | 1.75E−03 | 0.018853 | 0 | 0 | 1.94E−03 |
| 472 | 1.61E−03 | 0.0191932 | 0 | 0 | 1.98E−03 |
| 473 | 1.48E−03 | 0.019476 | 0 | 0 | 2.03E−03 |
| 474 | 1.36E−03 | 0.0197027 | 0 | 0 | 2.08E−03 |
| 475 | 1.24E−03 | 0.0198746 | 0 | 0 | 2.13E−03 |
| 476 | 1.14E−03 | 0.0199935 | 0 | 0 | 2.18E−03 |
| 477 | 1.04E−03 | 0.0200613 | 0 | 0 | 2.24E−03 |
| 478 | 9.44E−04 | 0.0200801 | 0 | 0 | 2.29E−03 |
| 479 | 8.59E−04 | 0.0200522 | 0 | 0 | 2.35E−03 |
| 480 | 7.81E−04 | 0.01998 | 0 | 0 | 2.40E−03 |
| 481 | 7.09E−04 | 0.0198658 | 0 | 0 | 2.46E−03 |
| 482 | 6.43E−04 | 0.0197121 | 0 | 0 | 2.52E−03 |
| 483 | 5.82E−04 | 0.0195214 | 0 | 0 | 2.58E−03 |
| 484 | 5.27E−04 | 0.0192962 | 0 | 0 | 2.64E−03 |
| 485 | 4.77E−04 | 0.0190389 | 0 | 0 | 2.70E−03 |
| 486 | 4.31E−04 | 0.018752 | 0 | 0 | 2.77E−03 |
| 487 | 3.89E−04 | 0.0184378 | 0 | 0 | 2.83E−03 |
| 488 | 3.51E−04 | 0.0180987 | 0 | 0 | 2.90E−03 |
| 489 | 3.16E−04 | 0.0177369 | 1E−08 | 0 | 2.97E−03 |
| 490 | 2.85E−04 | 0.0173548 | 3E−08 | 0 | 3.04E−03 |
| 491 | 2.56E−04 | 0.0169544 | 9E−08 | 0 | 3.11E−03 |
| 492 | 2.31E−04 | 0.0165378 | 2.3E−07 | 0 | 3.18E−03 |
| 493 | 2.08E−04 | 0.0161072 | 5.6E−07 | 0 | 3.25E−03 |
| 494 | 1.87E−04 | 0.0156643 | 1.24E−06 | 0 | 3.32E−03 |
| 495 | 1.68E−04 | 0.015211 | 0.0000026 | 0 | 3.40E−03 |
| 496 | 1.51E−04 | 0.0147493 | 5.19E−06 | 0 | 3.47E−03 |
| 497 | 1.36E−04 | 0.0142807 | 9.84E−06 | 0 | 3.55E−03 |
| 498 | 1.22E−04 | 0.013807 | 1.781E−05 | 0 | 3.62E−03 |
| 499 | 1.10E−04 | 0.0133296 | 3.088E−05 | 0 | 3.70E−03 |
| 500 | 9.85E−05 | 0.0128502 | 5.146E−05 | 0 | 3.77E−03 |
| 501 | 8.85E−05 | 0.0123702 | 8.263E−05 | 0 | 3.85E−03 |
| 502 | 7.95E−05 | 0.0118908 | 0.0001282 | 0 | 3.93E−03 |
| 503 | 7.14E−05 | 0.0114135 | 0.0001926 | 0 | 4.01E−03 |
| 504 | 6.42E−05 | 0.0109393 | 0.0002809 | 0 | 4.08E−03 |
| 505 | 5.77E−05 | 0.0104696 | 0.0003985 | 0 | 4.16E−03 |
| 506 | 5.18E−05 | 0.0100054 | 0.0005511 | 0 | 4.24E−03 |
| 507 | 4.66E−05 | 0.0095477 | 0.0007442 | 0 | 4.32E−03 |
| 508 | 4.19E−05 | 0.0090975 | 0.0009829 | 0 | 4.39E−03 |
| 509 | 3.76E−05 | 0.0086556 | 0.0012718 | 0 | 4.47E−03 |
| 510 | 3.38E−05 | 0.008223 | 0.0016143 | 0 | 4.55E−03 |
| 511 | 3.04E−05 | 0.0078003 | 0.0020131 | 0 | 4.63E−03 |
| 512 | 2.74E−05 | 0.0073883 | 0.0024691 | 0 | 4.70E−03 |
| 513 | 2.46E−05 | 0.0069875 | 0.0029822 | 0 | 4.78E−03 |
| 514 | 2.22E−05 | 0.0065986 | 0.0035508 | 0 | 4.86E−03 |
| 515 | 1.99E−05 | 0.0062221 | 0.0041719 | 0 | 4.93E−03 |
| 516 | 1.80E−05 | 0.0058582 | 0.0048411 | 0 | 5.01E−03 |
| 517 | 1.62E−05 | 0.0055075 | 0.0055532 | 0 | 5.08E−03 |
| 518 | 1.46E−05 | 0.0051701 | 0.0063019 | 0 | 5.15E−03 |
| 519 | 1.31E−05 | 0.0048462 | 0.0070802 | 0 | 5.22E−03 |
| 520 | 1.18E−05 | 0.0045361 | 0.0078805 | 0 | 5.30E−03 |
| 521 | 1.07E−05 | 0.0042397 | 0.0086952 | 0 | 5.37E−03 |
| 522 | 9.61E−06 | 0.0039571 | 0.0095163 | 0 | 5.44E−03 |
| 523 | 8.67E−06 | 0.0036882 | 0.0103361 | 0 | 5.51E−03 |
| 524 | 7.82E−06 | 0.0034329 | 0.0111471 | 0 | 5.58E−03 |
| 525 | 7.06E−06 | 0.003191 | 0.0119422 | 0 | 5.64E−03 |
| 526 | 6.37E−06 | 0.0029623 | 0.0127149 | 0 | 5.71E−03 |
| 527 | 5.76E−06 | 0.0027465 | 0.0134591 | 0 | 5.77E−03 |
| 528 | 5.20E−06 | 0.0025433 | 0.0141696 | 0 | 5.84E−03 |
| 529 | 4.70E−06 | 0.0023523 | 0.0148416 | 0 | 5.90E−03 |
| 530 | 4.25E−06 | 0.0021732 | 0.0154714 | 0 | 5.97E−03 |
| 531 | 3.84E−06 | 0.0020055 | 0.0160555 | 0 | 6.03E−03 |
| 532 | 3.48E−06 | 0.0018487 | 0.0165915 | 0 | 6.09E−03 |
| 533 | 3.14E−06 | 0.0017025 | 0.0170775 | 0 | 6.15E−03 |
| 534 | 2.85E−06 | 0.0015663 | 0.017512 | 0 | 6.21E−03 |
| 535 | 2.58E−06 | 0.0014396 | 0.0178945 | 0 | 6.27E−03 |
| 536 | 2.33E−06 | 0.001322 | 0.0182246 | 0 | 6.32E−03 |
| 537 | 2.11E−06 | 0.0012131 | 0.0185026 | 0 | 6.38E−03 |
| 538 | 1.92E−06 | 0.0011122 | 0.0187292 | 0 | 6.43E−03 |
| 539 | 1.74E−06 | 0.0010189 | 0.0189053 | 0 | 6.48E−03 |
| 540 | 1.58E−06 | 0.0009329 | 0.0190322 | 0 | 6.53E−03 |
| 541 | 1.43E−06 | 0.0008535 | 0.0191116 | 1E−08 | 6.58E−03 |
| 542 | 1.30E−06 | 0.0007804 | 0.0191452 | 2E−08 | 6.63E−03 |
| 543 | 1.18E−06 | 0.0007132 | 0.0191349 | 4E−08 | 6.67E−03 |
| 544 | 1.07E−06 | 0.0006514 | 0.019083 | 8E−08 | 6.72E−03 |
| 545 | 9.70E−07 | 0.0005947 | 0.0189916 | 1.7E−07 | 6.76E−03 |
| 546 | 8.80E−07 | 0.0005427 | 0.018863 | 3.3E−07 | 6.80E−03 |
| 547 | 8.00E−07 | 0.0004951 | 0.0186996 | 6.3E−07 | 6.84E−03 |
| 548 | 7.30E−07 | 0.0004515 | 0.0185036 | 1.17E−06 | 6.88E−03 |
| 549 | 6.60E−07 | 0.0004115 | 0.0182775 | 2.09E−06 | 6.92E−03 |
| 550 | 6.00E−07 | 0.000375 | 0.0180236 | 0.0000036 | 6.95E−03 |
| 551 | 5.50E−07 | 0.0003417 | 0.0177442 | 6.03E−06 | 6.99E−03 |
| 552 | 5.00E−07 | 0.0003112 | 0.0174416 | 9.81E−06 | 7.02E−03 |
| 553 | 4.60E−07 | 0.0002835 | 0.017118 | 1.552E−05 | 7.05E−03 |
| 554 | 4.20E−07 | 0.0002581 | 0.0167755 | 2.394E−05 | 7.08E−03 |
| 555 | 3.80E−07 | 0.000235 | 0.0164161 | 3.601E−05 | 7.10E−03 |
| 556 | 3.50E−07 | 0.0002139 | 0.016042 | 5.295E−05 | 7.12E−03 |
| 557 | 3.20E−07 | 0.0001947 | 0.015655 | 7.617E−05 | 7.15E−03 |
| 558 | 2.90E−07 | 0.0001772 | 0.0152569 | 0.0001073 | 7.17E−03 |
| 559 | 2.60E−07 | 0.0001613 | 0.0148494 | 0.0001483 | 7.18E−03 |
| 560 | 2.40E−07 | 0.0001468 | 0.0144344 | 0.0002013 | 7.20E−03 |
| 561 | 2.20E−07 | 0.0001336 | 0.0140132 | 0.0002684 | 7.21E−03 |
| 562 | 2.00E−07 | 0.0001216 | 0.0135874 | 0.000352 | 7.22E−03 |
| 563 | 1.80E−07 | 0.0001107 | 0.0131585 | 0.0004547 | 7.23E−03 |
| 564 | 1.70E−07 | 0.0001008 | 0.0127277 | 0.0005787 | 7.23E−03 |
| 565 | 1.50E−07 | 9.174E−05 | 0.0122962 | 0.0007263 | 7.24E−03 |
| 566 | 1.40E−07 | 8.352E−05 | 0.0118653 | 0.0008998 | 7.24E−03 |
| 567 | 1.30E−07 | 7.605E−05 | 0.0114361 | 0.001101 | 7.24E−03 |
| 568 | 1.20E−07 | 6.925E−05 | 0.0110094 | 0.0013315 | 7.23E−03 |
| 569 | 1.10E−07 | 6.307E−05 | 0.0105864 | 0.0015926 | 7.22E−03 |
| 570 | 1.00E−07 | 5.745E−05 | 0.0101679 | 0.0018849 | 7.21E−03 |
| 571 | 9.00E−08 | 5.233E−05 | 0.0097547 | 0.002209 | 7.20E−03 |
| 572 | 8.00E−08 | 4.768E−05 | 0.0093475 | 0.0025645 | 7.18E−03 |
| 573 | 8.00E−08 | 4.345E−05 | 0.0089471 | 0.002951 | 7.16E−03 |
| 574 | 7.00E−08 | 0.0000396 | 0.0085541 | 0.0033674 | 7.14E−03 |
| 575 | 6.00E−08 | 0.0000361 | 0.0081689 | 0.003812 | 7.12E−03 |
| 576 | 6.00E−08 | 3.292E−05 | 0.0077923 | 0.004283 | 7.10E−03 |
| 577 | 5.00E−08 | 3.002E−05 | 0.0074246 | 0.0047779 | 7.07E−03 |
| 578 | 5.00E−08 | 2.738E−05 | 0.0070663 | 0.0052941 | 7.04E−03 |
| 579 | 4.00E−08 | 2.498E−05 | 0.0067176 | 0.0058286 | 7.01E−03 |
| 580 | 4.00E−08 | 2.279E−05 | 0.006379 | 0.0063782 | 6.98E−03 |
| 581 | 4.00E−08 | 0.0000208 | 0.0060507 | 0.0069395 | 6.94E−03 |
| 582 | 3.00E−08 | 1.899E−05 | 0.0057328 | 0.0075091 | 6.91E−03 |
| 583 | 3.00E−08 | 1.734E−05 | 0.0054257 | 0.0080832 | 6.87E−03 |
| 584 | 3.00E−08 | 1.584E−05 | 0.0051294 | 0.0086586 | 6.83E−03 |
| 585 | 3.00E−08 | 1.447E−05 | 0.0048439 | 0.0092315 | 6.78E−03 |
| 586 | 2.00E−08 | 1.322E−05 | 0.0045695 | 0.0097986 | 6.74E−03 |
| 587 | 2.00E−08 | 1.209E−05 | 0.0043059 | 0.0103567 | 6.69E−03 |
| 588 | 2.00E−08 | 1.105E−05 | 0.0040533 | 0.0109026 | 6.64E−03 |
| 589 | 2.00E−08 | 0.0000101 | 0.0038116 | 0.0114334 | 6.58E−03 |
| 590 | 2.00E−08 | 9.24E−06 | 0.0035806 | 0.0119465 | 6.52E−03 |
| 591 | 2.00E−08 | 8.45E−06 | 0.0033602 | 0.0124392 | 6.46E−03 |
| 592 | 2.00E−08 | 7.74E−06 | 0.0031503 | 0.0129094 | 6.40E−03 |
| 593 | 1.00E−08 | 7.08E−06 | 0.0029506 | 0.0133552 | 6.33E−03 |
| 594 | 1.00E−08 | 6.48E−06 | 0.002761 | 0.0137748 | 6.26E−03 |
| 595 | 1.00E−08 | 5.94E−06 | 0.0025811 | 0.0141667 | 6.19E−03 |
| 596 | 1.00E−08 | 5.44E−06 | 0.0024109 | 0.0145298 | 6.12E−03 |
| 597 | 1.00E−08 | 4.98E−06 | 0.0022498 | 0.014863 | 6.04E−03 |
| 598 | 1.00E−08 | 4.57E−06 | 0.0020978 | 0.0151657 | 5.96E−03 |
| 599 | 1.00E−08 | 4.19E−06 | 0.0019544 | 0.0154373 | 5.88E−03 |
| 600 | 1.00E−08 | 3.84E−06 | 0.0018194 | 0.0156775 | 5.80E−03 |
| 601 | 1.00E−08 | 3.52E−06 | 0.0016925 | 0.0158863 | 5.71E−03 |
| 602 | 1.00E−08 | 3.23E−06 | 0.0015732 | 0.0160638 | 5.63E−03 |
| 603 | 1.00E−08 | 2.97E−06 | 0.0014613 | 0.0162101 | 5.54E−03 |
| 604 | 1.00E−08 | 2.72E−06 | 0.0013565 | 0.0163258 | 5.45E−03 |
| 605 | 1.00E−08 | 0.0000025 | 0.0012583 | 0.0164113 | 5.36E−03 |
| 606 | 0.00E+00 | 0.0000023 | 0.0011666 | 0.0164673 | 5.26E−03 |
| 607 | 0.00E+00 | 2.11E−06 | 0.0010809 | 0.0164948 | 5.17E−03 |
| 608 | 0.00E+00 | 1.94E−06 | 0.0010009 | 0.0164944 | 5.07E−03 |
| 609 | 0.00E+00 | 1.78E−06 | 0.0009264 | 0.0164672 | 4.98E−03 |
| 610 | 0.00E+00 | 1.64E−06 | 0.000857 | 0.0164143 | 4.88E−03 |
| 611 | 0.00E+00 | 1.51E−06 | 0.0007924 | 0.0163367 | 4.78E−03 |
| 612 | 0.00E+00 | 1.38E−06 | 0.0007324 | 0.0162355 | 4.68E−03 |
| 613 | 0.00E+00 | 1.27E−06 | 0.0006766 | 0.0161121 | 4.58E−03 |
| 614 | 0.00E+00 | 1.17E−06 | 0.0006249 | 0.0159675 | 4.48E−03 |
| 615 | 0.00E+00 | 1.08E−06 | 0.0005769 | 0.015803 | 4.38E−03 |
| 616 | 0.00E+00 | 9.9E−07 | 0.0005324 | 0.0156198 | 4.28E−03 |
| 617 | 0.00E+00 | 9.2E−07 | 0.0004912 | 0.0154192 | 4.18E−03 |
| 618 | 0.00E+00 | 8.4E−07 | 0.0004531 | 0.0152023 | 4.08E−03 |
| 619 | 0.00E+00 | 7.8E−07 | 0.0004178 | 0.0149705 | 3.98E−03 |
| 620 | 0.00E+00 | 7.2E−07 | 0.0003852 | 0.0147249 | 3.88E−03 |
| 621 | 0.00E+00 | 6.6E−07 | 0.000355 | 0.0144667 | 3.78E−03 |
| 622 | 0.00E+00 | 6.1E−07 | 0.0003272 | 0.0141971 | 3.68E−03 |
| 623 | 0.00E+00 | 5.6E−07 | 0.0003015 | 0.0139171 | 3.58E−03 |
| 624 | 0.00E+00 | 5.2E−07 | 0.0002777 | 0.013628 | 3.48E−03 |
| 625 | 0.00E+00 | 4.8E−07 | 0.0002558 | 0.0133307 | 3.38E−03 |
| 626 | 0.00E+00 | 4.4E−07 | 0.0002356 | 0.0130263 | 3.28E−03 |
| 627 | 0.00E+00 | 4.1E−07 | 0.000217 | 0.0127158 | 3.18E−03 |
| 628 | 0.00E+00 | 3.8E−07 | 0.0001998 | 0.0124001 | 3.08E−03 |
| 629 | 0.00E+00 | 3.5E−07 | 0.000184 | 0.0120802 | 2.99E−03 |
| 630 | 0.00E+00 | 3.2E−07 | 0.0001695 | 0.0117569 | 2.89E−03 |
| 631 | 0.00E+00 | 0.0000003 | 0.000156 | 0.0114312 | 2.80E−03 |
| 632 | 0.00E+00 | 2.7E−07 | 0.0001437 | 0.0111037 | 2.71E−03 |
| 633 | 0.00E+00 | 2.5E−07 | 0.0001323 | 0.0107753 | 2.62E−03 |
| 634 | 0.00E+00 | 2.3E−07 | 0.0001218 | 0.0104467 | 2.53E−03 |
| 635 | 0.00E+00 | 2.2E−07 | 0.0001122 | 0.0101185 | 2.44E−03 |
| 636 | 0.00E+00 | 0.0000002 | 0.0001033 | 0.0097915 | 2.35E−03 |
| 637 | 0.00E+00 | 1.9E−07 | 9.512E−05 | 0.0094662 | 2.27E−03 |
| 638 | 0.00E+00 | 1.7E−07 | 0.0000876 | 0.0091432 | 2.18E−03 |
| 639 | 0.00E+00 | 1.6E−07 | 8.068E−05 | 0.0088231 | 2.10E−03 |
| 640 | 0.00E+00 | 1.5E−07 | 7.431E−05 | 0.0085063 | 2.02E−03 |
| 641 | 0.00E+00 | 1.4E−07 | 6.845E−05 | 0.0081934 | 1.94E−03 |
| 642 | 0.00E+00 | 1.3E−07 | 6.306E−05 | 0.0078848 | 1.86E−03 |
| 643 | 0.00E+00 | 1.2E−07 | 0.0000581 | 0.0075808 | 1.79E−03 |
| 644 | 0.00E+00 | 1.1E−07 | 5.354E−05 | 0.0072819 | 1.71E−03 |
| 645 | 0.00E+00 | 0.0000001 | 4.934E−05 | 0.0069885 | 1.64E−03 |
| 646 | 0.00E+00 | 9E−08 | 4.547E−05 | 0.0067008 | 1.57E−03 |
| 647 | 0.00E+00 | 9E−08 | 4.192E−05 | 0.0064191 | 1.50E−03 |
| 648 | 0.00E+00 | 8E−08 | 3.864E−05 | 0.0061438 | 1.43E−03 |
| 649 | 0.00E+00 | 7E−08 | 3.563E−05 | 0.0058749 | 1.37E−03 |
| 650 | 0.00E+00 | 7E−08 | 3.286E−05 | 0.0056128 | 1.31E−03 |
| 651 | 0.00E+00 | 6E−08 | 3.031E−05 | 0.0053575 | 1.24E−03 |
| 652 | 0.00E+00 | 6E−08 | 2.796E−05 | 0.0051094 | 1.19E−03 |
| 653 | 0.00E+00 | 6E−08 | 2.579E−05 | 0.0048684 | 1.13E−03 |
| 654 | 0.00E+00 | 5E−08 | 0.0000238 | 0.0046347 | 1.07E−03 |
| 655 | 0.00E+00 | 5E−08 | 2.196E−05 | 0.0044084 | 1.02E−03 |
| 656 | 0.00E+00 | 4E−08 | 2.027E−05 | 0.0041895 | 9.68E−04 |
| 657 | 0.00E+00 | 4E−08 | 1.872E−05 | 0.0039781 | 9.19E−04 |
| 658 | 0.00E+00 | 4E−08 | 1.728E−05 | 0.0037741 | 8.71E−04 |
| 659 | 0.00E+00 | 4E−08 | 1.596E−05 | 0.0035776 | 8.25E−04 |
| 660 | 0.00E+00 | 3E−08 | 1.474E−05 | 0.0033885 | 7.81E−04 |
| 661 | 0.00E+00 | 3E−08 | 1.362E−05 | 0.0032067 | 7.38E−04 |
| 662 | 0.00E+00 | 3E−08 | 1.259E−05 | 0.0030323 | 6.97E−04 |
| 663 | 0.00E+00 | 3E−08 | 1.163E−05 | 0.0028651 | 6.59E−04 |
| 664 | 0.00E+00 | 3E−08 | 1.075E−05 | 0.002705 | 6.21E−04 |
| 665 | 0.00E+00 | 2E−08 | 9.94E−06 | 0.0025519 | 5.86E−04 |
| 666 | 0.00E+00 | 2E−08 | 9.19E−06 | 0.0024056 | 5.52E−04 |
| 667 | 0.00E+00 | 2E−08 | 0.0000085 | 0.0022661 | 5.20E−04 |
| 668 | 0.00E+00 | 2E−08 | 7.87E−06 | 0.0021331 | 4.89E−04 |
| 669 | 0.00E+00 | 2E−08 | 7.28E−06 | 0.0020066 | 4.60E−04 |
| 670 | 0.00E+00 | 2E−08 | 6.74E−06 | 0.0018862 | 4.32E−04 |
| 671 | 0.00E+00 | 2E−08 | 6.23E−06 | 0.0017719 | 4.06E−04 |
| 672 | 0.00E+00 | 1E−08 | 5.77E−06 | 0.0016635 | 3.81E−04 |
| 673 | 0.00E+00 | 1E−08 | 5.34E−06 | 0.0015607 | 3.58E−04 |
| 674 | 0.00E+00 | 1E−08 | 4.95E−06 | 0.0014634 | 3.35E−04 |
| 675 | 0.00E+00 | 1E−08 | 4.59E−06 | 0.0013714 | 3.14E−04 |
| 676 | 0.00E+00 | 1E−08 | 4.25E−06 | 0.0012844 | 2.94E−04 |
| 677 | 0.00E+00 | 1E−08 | 3.94E−06 | 0.0012024 | 2.75E−04 |
| 678 | 0.00E+00 | 1E−08 | 3.65E−06 | 0.0011249 | 2.58E−04 |
| 679 | 0.00E+00 | 1E−08 | 3.38E−06 | 0.001052 | 2.41E−04 |
| 680 | 0.00E+00 | 1E−08 | 3.14E−06 | 0.0009833 | 2.25E−04 |
| 681 | 0.00E+00 | 1E−08 | 2.91E−06 | 0.0009186 | 2.10E−04 |
| 682 | 0.00E+00 | 1E−08 | 0.0000027 | 0.0008579 | 1.96E−04 |
| 683 | 0.00E+00 | 1E−08 | 2.51E−06 | 0.0008008 | 1.83E−04 |
| 684 | 0.00E+00 | 1E−08 | 2.32E−06 | 0.0007473 | 1.71E−04 |
| 685 | 0.00E+00 | 1E−08 | 2.16E−06 | 0.000697 | 1.60E−04 |
| 686 | 0.00E+00 | 1E−08 | 0.000002 | 0.0006499 | 1.49E−04 |
| 687 | 0.00E+00 | 1E−08 | 1.86E−06 | 0.0006058 | 1.39E−04 |
| 688 | 0.00E+00 | 0 | 1.73E−06 | 0.0005646 | 1.29E−04 |
| 689 | 0.00E+00 | 0 | 1.61E−06 | 0.0005259 | 1.20E−04 |
| 690 | 0.00E+00 | 0 | 1.49E−06 | 0.0004898 | 1.12E−04 |
| 691 | 0.00E+00 | 0 | 1.39E−06 | 0.0004561 | 1.04E−04 |
| 692 | 0.00E+00 | 0 | 1.29E−06 | 0.0004246 | 9.73E−05 |
| 693 | 0.00E+00 | 0 | 0.0000012 | 0.0003951 | 9.05E−05 |
| 694 | 0.00E+00 | 0 | 1.11E−06 | 0.0003677 | 8.43E−05 |
| 695 | 0.00E+00 | 0 | 1.04E−06 | 0.0003421 | 7.84E−05 |
| 696 | 0.00E+00 | 0 | 9.6E−07 | 0.0003182 | 7.29E−05 |
| 697 | 0.00E+00 | 0 | 0.0000009 | 0.0002959 | 6.78E−05 |
| 698 | 0.00E+00 | 0 | 8.4E−07 | 0.0002752 | 6.31E−05 |
| 699 | 0.00E+00 | 0 | 7.8E−07 | 0.0002559 | 5.86E−05 |
| 700 | 0.00E+00 | 0 | 7.2E−07 | 0.0002379 | 5.45E−05 |

Although particular embodiments of the present invention have been illustrated and described, it is obvious that various other changes and modifications may be made within the spirit and scope of the invention. The present text is therefore intended to cover in the appended claims all modifications that fall within the scope of the present invention.

1. A multi-glazed unit adapted to be mounted in a building, on a facade and/or on the roof, comprising at least one exterior laminated glazed unit and an interior glazed unit separated by a gas gap and intended respectively to be arranged towards the exterior and interior of the building, said exterior laminated glazed unit comprising at least one electrochromic stack and a lamination interlayer, interposed between an interior transparent substrate and an exterior transparent substrate comprising on its exterior face a textured pattern which contrasts with a background, wherein:
each subset of said textured pattern is separated from an adjacent subset by a distance less than 10.16 cm,
said textured pattern has relative to the background a visibility SCORE greater than or equal to 0, and which satisfies the equation:
SCORE=0.85*ΔS+0.15*ΔL
Where ΔS is the chromatic contrast and satisfies the equation
$$Δ S = \sqrt{\begin{matrix}{( {w}_{1} {w}_{2} )}^{2} {( Δ {f}_{4} - Δ {f}_{3} )}^{2} + {( {w}_{1} {w}_{3} )}^{2} {( Δ {f}_{4} - Δ {f}_{2} )}^{2} + {( {w}_{1} {w}_{4} )}^{2} {( Δ {f}_{3} - Δ {f}_{2} )}^{2} + \\ {( {w}_{2} {w}_{3} )}^{2} {( Δ {f}_{4} - Δ {f}_{1} )}^{2} + {( {w}_{2} {w}_{4} )}^{2} {( Δ {f}_{3} - Δ {f}_{1} )}^{2} + {( {w}_{3} {w}_{4} )}^{2} {( Δ {f}_{2} - Δ {f}_{1} )}^{2} / \\ ( {( {w}_{1} {w}_{2} {w}_{3} )}^{2} + {( {w}_{1} {w}_{2} {w}_{4} )}^{2} + {( {w}_{1} {w}_{3} {w}_{4} )}^{2} + {( {w}_{2} {w}_{3} {w}_{4} )}^{2} )\end{matrix}}$$
Where “wi” is the Weber fraction representing the sensitivity of a cone “i” of the retina of a bird, with w_{&}=0.2; w₂=0.14142; w₃=0.14142 and w₄=0.1,
Where “Δfi” is the real perception difference between said pattern and the background,
Where “fi” satisfies the equation:
fi=ln(Qi/Qi_ref)
where Qi is the sensory response of a cone “i” of the retina of a bird and satisfies the equation
Qᵢ=∫_{λ}Rᵢ(λ)S(λ)I(λ)dλ
Where “λ” is the wavelength, “S” is the considered spectrum, “I” is the illuminant D65 according to standard EN410 which describes the average solar spectrum and “Ri” is the sensitivity spectrum of said cone “i”,
Where “Qi_ref” corresponds to “Qi” with S equal to 1,
Where “ΔL” is the achromatic contrast and satisfies the equation:
ΔL=Δf_achromatic/w_achromatic
Where “w_achromatic” is equal to 0.1 is the Weber fraction representing the achromatic sensitivity of the retina of a bird,
Where “Δf_achromatic” is the difference in real achromatic perception between said pattern and the background,
Where “f_achromatic” satisfies the equation: f_achromatic=In (Q/Q_ref)
Where Q is the achromatic sensory response of the retina of a bird and satisfies the equation
Q=ƒ_{λ}R(λ)S(λ)I(λ)dλ
Where “R” is the achromatic sensitivity spectrum,
Where “Q_ref” corresponds to “Q” with S equal to 1,

2. The multi-glazed unit according to claim 1, wherein said interior transparent substrate is coated with said electrochromic.

3. The multi-glazed unit according to claim 1, comprising at least one reflective layer arranged between the interior transparent substrate and the external face of the exterior transparent substrate.

4. The multi-glazed unit according to claim 3, wherein said at least one reflective layer is arranged on the inner face of the transparent exterior substrate.

5. The multi-glazed unit according to claim 3, wherein said at least one reflective layer is composed of silicon nitride and/or of oxide MOx (M=Si, Sn, Zn) and/or of metal M (M=Ni, Cr, Ti, Ag).

6. The multi-glazed unit according to claim 1, wherein said texture pattern comprises wavy or rectilinear strips.

7. The multi-glazed unit according to claim 1, wherein said texture pattern comprises dots.

8. A method comprising manufacturing a multi-glazed unit according to claim 1.

9. A method comprising mounting in a building, on a facade and/or on the roof, a multi-glazed unit according to claim 1.

10. The multi-glazed unit according to claim 1, wherein the lamination interlayer is made of polymer material.

11. The multi-glazed unit according to claim 10, wherein the polymer material is polyvinyl butyral (PVB).

12. The multi-glazed unit according to claim 1, wherein each subset of said textured pattern is separated from an adjacent subset by a distance less than 5.08 cm.

13. The multi-glazed unit according to claim 2, wherein said electrochromic stack is in contact with said gas gap.
